(19) United States
(12) Patent Application Publication
(10) Pub. No.: US 2020/0104938 A1
(43) Pub. Date: Apr. 2, 2020

(54) COMPUTER-IMPLEMENTED METHOD OF PROCESSING AN INSURANCE CLAIM

(71) Applicant: Petsure (Australia) Pty Ltd, Castle Hill (AU)

(72) Inventors: CLAUDIO GOROJOVSKY, CHATSWOOD (AU); MICHAEL KING, CHATSWOOD (AU); TOBY YOO, CHATSWOOD (AU)

(21) Appl. No.: 16/178,287

(22) Filed: Nov. 1, 2018

(30) Foreign Application Priority Data
Sep. 28, 2018 (AU) 2018903667
Oct. 29, 2018 (AU) 2018253643

(51) Int. Cl. G06Q 40/08; G06F 16/2458; G06Q 10/10

(52) U.S. Cl. CPC G06Q 40/08; G06Q 10/10; G06F 16/2474

(57) ABSTRACT

The present disclosure is directed broadly to a computer-implemented method of processing or monitoring an insurance claim according to alternative aspects of the disclosure. The processing or monitoring methods are each enabled via a computer system and an associated software platform. The software platform is built in a microservices architecture including application program interface (API) components. The alternative methods enable bi-directional communication of claim data and other information associated with the insurance claim between a veterinary practice management system (VPMS) of the veterinary practice and the insurance provider.

This application claims the benefit under 35 USC 119 of applicant's earlier-filed Australian Provisional Patent Application No. 2018903667 filed Sep. 28, 2018 and Australian Patent Application No. 2018253643 filed Oct. 29, 2018. The contents of the specification accompanying the applicant's prior applications are to be considered incorporated herein by reference.

### TECHNICAL FIELD

The present disclosure relates broadly to a computer-implemented method of processing or monitoring an insurance claim for treatment of an animal. The disclosure is also broadly directed to a computer system for processing or monitoring an animal insurance claim.

### SUMMARY OF DISCLOSURE

According to a first aspect of the present disclosure there is provided a computer-implemented method of processing an insurance claim, the method including receiving claim data associated with an insurance claim for treatment of an animal at a veterinary practice, processing the claim data to provide a claim workflow derived from said claim data, storing the claim workflow in a claim workflow database, retrieving the claim workflow from the claim workflow database, and processing the claim workflow to provide an integrated claim workflow in a format compatible for submission to an insurance provider for assessment of the insurance claim.

The step of retrieving the claim workflow from the claim workflow database may involve electronically querying the claim workflow database to identify claim workflows eligible for retrieval from the claim workflow database. Further the step of querying the claim workflow database may involve periodic polling of said database which on identification of an eligible claim workflow responds with said workflow. Still further the eligible claim workflow may be downloaded from the claim workflow database for processing to provide the integrated claim workflow.

The method may also comprise a step of receiving supplementary information associated with the animal for which the insurance claim is made. Further the supplementary information may be stored together with the claim workflow in the claim workflow database. Still further the step of processing the claim workflow may involve consolidating the supplementary information from the claim workflow database into a single data file for inclusion in the integrated claim workflow for submission to the insurance provider. Moreover, the supplementary information may include but is not limited to claims declarations, medical reports, historical medical records and other documents relevant to the insurance claim for the animal.

The method may also comprise a step of validating a policy number from the claim data of an insurance policy under which the insurance claim is made. The policy number may be validated by reconciling it with a corresponding policy number associated with corresponding policy information maintained by the insurance provider. In the event the policy number fails to reconcile with the corresponding policy number, the policy number is automatically corrected to the corresponding policy number.

The claim data is received from the veterinary practice having been converted into a compatible data format by application of a canonical data model at the veterinary practice. The insurance claim including the claim data in the compatible data format is electronically lodged from the veterinary practice for storage at the claim workflow database.

The method enables bi-directional communication of claim data and other information associated with the insurance claim between a veterinary practice management system (VPMS) of the veterinary practice and the insurance provider.

According to a second aspect of the disclosure there is provided a computer system for processing an animal insurance claim. The system includes a storage component including a claim workflow database for storing a claim workflow derived from claim data associated with an insurance claim for treatment of an animal, an insurance integration component arranged to communicate with the storage component. The integration component may include a retrieval component configured to retrieve the claim workflow from the claim workflow database and a processing component configured to process the claim workflow to provide an integrated claim workflow in a format compatible for submission to an insurance provider for assessment of the insurance claim.

According to a third aspect of the disclosure there is provided a computer system for processing an animal insurance claim including a processor, a memory device which stores a plurality of instructions which when executed by the processor cause the processor to: receive claim data associated with an insurance claim for treatment of an animal at a veterinary practice, process the claim data to provide a claim data workflow derived from said claim data, store the claim workflow in a claim workflow database, retrieve the claim workflow from the claim workflow database, and process the claim workflow to provide an integrated claim workflow in a format compatible for submission to an insurance provider for assessment of the insurance claim.

According to a fourth aspect of the disclosure there is provided a computer-implemented method of monitoring an insurance claim. The method includes electronically querying an insurance provider in relation to a status of an insurance claim for treatment of an animal at a veterinary practice, in the event of a change in the status of the insurance claim, retrieving an updated status from the insurance provider, converting the updated status to a compatible data format capable of being read by the veterinary practice, storing the updated status in the compatible data format in a claim workflow database, and electronically communicating the updated status from the claim workflow database to the veterinary practice in the compatible data format.

The method may also comprise a step of storing the updated status in an insurance integration database for conversion to the compatible data format. Further the method may also include a step of retrieving the updated status in the compatible data format for storage in the claim workflow database. Still further the retrieval of the updated status involves pushing the updated status from the insurance integration database to the claim workflow database in the compatible data format.

The step of electronically informing the veterinary practice of the updated status in the compatible data format is effected by prompted delivery of the updated status in response to periodic polling from the veterinary practice. Alternatively the updated status in the compatible data format is communicated to the veterinary practice by calling the veterinary practice for pushing of the updated claim status to said practice.

The step of electronically querying the insurance provider may involve periodically polling the insurance provider in relation to the status of the insurance claim. In the event of a change in the status, the step of retrieving the updated status may involve the insurance provider responding to the periodic polling with the updated status.

The method may be implemented via a software platform built in a microservices architecture including user interface (UI) and application program interface (API) components.

According to a fifth aspect of the disclosure there is provided a computer system for monitoring an animal insurance claim. The method includes a querying component configured to electronically query an insurance provider in relation to a change in the status of an insurance claim for treatment of an animal at a veterinary practice, a retrieval component, in the event of a change in the status of the insurance claim, being configured to retrieve an updated status from the insurance provider, a conversion component being configured to convert the updated status to a compatible data format capable of being read by the veterinary practice, and a storage component including a claim workflow database for storing the updated status in the compatible data format for electronic communication of the updated status to the veterinary practice.

According to a sixth aspect of the disclosure there is provided a computer system for monitoring an animal insurance claim. The system includes a processor, a memory device which stores a plurality of instructions which when executed by the processor cause the processor to electronically query an insurance provider in relation to a status of an insurance claim for treatment of an animal at a veterinary practice. In the event of a change in the status of the insurance claim, retrieve an updated status from the insurance provider, convert the updated status to a compatible data format capable of being read by the veterinary practice, and store the updated status of the insurance claim in a claim workflow database for electronic communication of the updated status from the claim to the veterinary practice.

### BRIEF DESCRIPTION OF DRAWINGS

In order to achieve a better understanding of the nature of the present disclosure a preferred embodiment of a computer implemented method of processing or monitoring an insurance claim for treatment of an animal will now be described, by way of example only, with reference to the accompanying illustrations in which:

FIG. 1 is a schematic flow diagram showing data flow between the various components of a computer system including a software platform for processing or monitoring an animal insurance claim according to alternative aspects of the disclosure;

FIG. 2 is a schematic flow diagram of a computer-implemented method of processing an insurance claim according to one aspect of the disclosure illustrating implementation of the method via the software platform of FIG. 1 built in a microservice architecture;

FIG. 3 is a schematic flow diagram of a method of monitoring an insurance claim according to another aspect of the disclosure illustrating implementation of the method via the software platform of FIG. 1 built in a microservice architecture;

FIGS. 4A and 4B are schematic block diagrams depicting workflows and data flow from the computer system and the method of the preceding figures.

### DETAILED DESCRIPTION

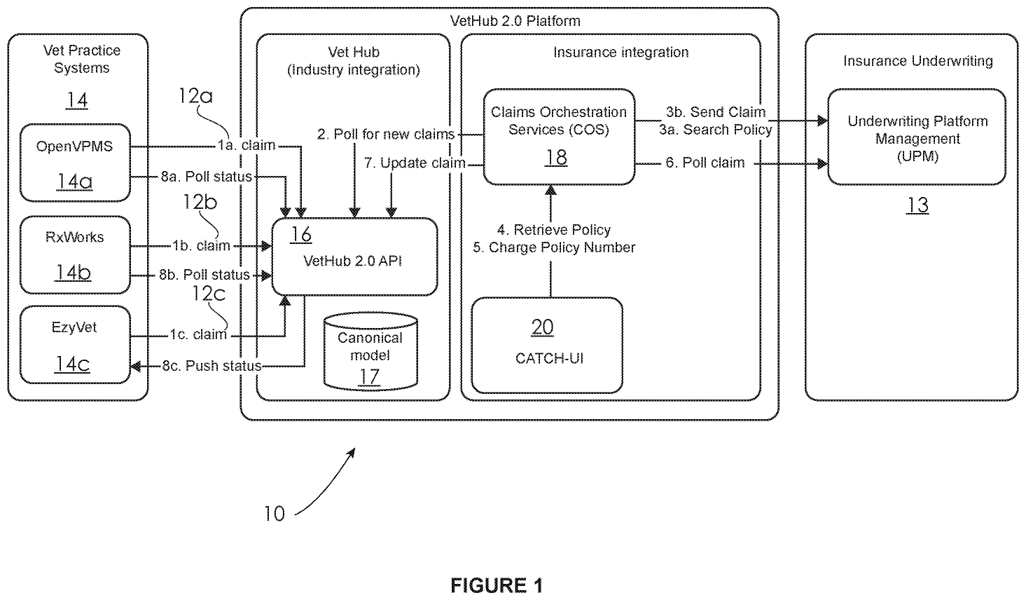

As seen in FIG. 1, there is a computer-implemented method of processing or monitoring an insurance claim according to alternative aspects of the disclosure. The processing method of one aspect is enabled via a computer system and an associated software platform 10 which in this embodiment performs the steps of:
1. receiving claim data at 12a to 12c associated with an insurance claim made under an insurance policy of an insurance provider 13, the insurance claim being made in respect of treatment of an animal at a veterinary practice 14;
2. processing the claim data at 16 to provide a claim workflow derived from the claim data such as 12a;
3. storing the claim workflow in a claim workflow database schematically depicted at 17;
4. retrieving the claim workflow from the claim workflow database 17;
5. processing the claim workflow at 18 to provide an integrated claim workflow in a format compatible for submission to the insurance provider at 13 for assessment of the insurance claim.

In this embodiment the integrated claim workflow is derived from the claim workflow and constructed at a claims orchestration service (COS) at 18. The COS 18 is modular in the sense that it is tailored to align the integrated claim workflow and associated data with the insurance provider or more particularly an underwriting platform management (UPM) 13. The COS 18 thus provides a bridge to the UPM 13 by translating the claim workflow of an associated application program interface (API) at 16 into an integrated claim workflow which is compatible with the selected UPM 13.

The monitoring method of another aspect of the disclosure is enabled via the computer system and associated software platform 10 which in this embodiment broadly performs the steps of:
1. electronically querying the insurance provider or UPM 13 in relation to a status of an insurance claim for treatment of an animal at a veterinary practice such as 14a;
2. in the event of a change in the status of the insurance claim, retrieving an updated status from the insurance provider or UPM 13;
3. converting the updated status at 16 to a compatible data format capable of being read by the veterinary practice such as 14a;
4. storing the updated status in the compatible data format in a claim workflow database schematically depicted at 17;
5. electronically informing the veterinary practice such as 14a of the updated status in the compatible data format from the claim workflow database at 17.

In this embodiment the compatible data format for the updated status is based on a canonical data model. This canonical data model is an industry standard consistent with claim data received from the veterinary practice, or the veterinary practice management system (VPMS) such as 14a.

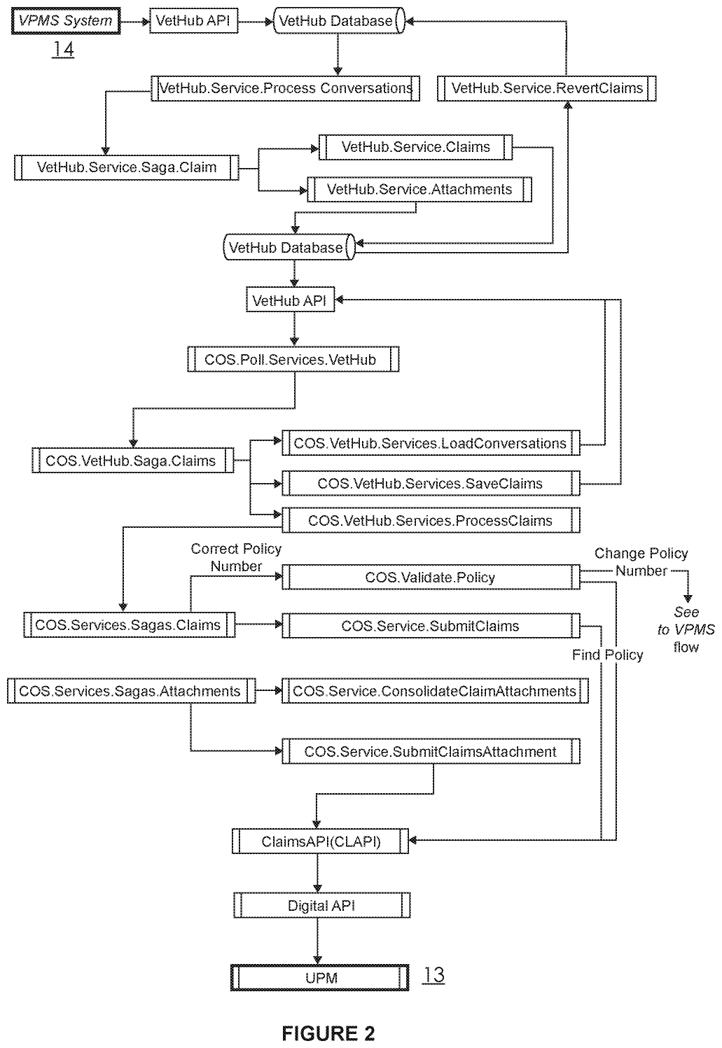

FIG. 2 illustrates in more detail the software platform 10 of one embodiment of the disclosure directed to processing of an insurance claim and built in the microservice architecture. Implementation of the preferred methodology may use the Saga pattern to manage workflows within the illustrated software platform. The microservices of this embodiment and of relevance to FIG. 2 are listed below:

| | Type | |
|---|---|---|
| | Windows/ | |
| Service Name | NServiceBus | Description |
| VetHub.Service. | Windows | Service to read all new conversations submitted to |
| ProcessCoversations | | VetHub API and push them to VetHub Saga. |
| VetHub.Service.Saga.Claim | NServiceBus | Saga for VetHub inbound claims workflow. |
| VetHub.Service.Claims | NServiceBus | Service to process conversations and mark them |
| | | ready for download |
| VetHub.Service.Attachments | NServiceBus | Generates attachments for RxWorks claims |
| VetHub.Service.RevertClaims | NServiceBus | Re-process failed conversations. |
| COS.Poll.Services.VetHub | Windows | Poll for conversation which are ready to download |
| | | and push them to COS.VetHub.Saga.Claims queue |
| COS.VetHub.Saga.Claims | NServiceBus | Saga for COS inbound claims workflow from |
| | | VetHub. |
| COS.VetHub.Services.LoadConversations | NServiceBus | Service to load all conversations to COS VetHub |
| | | Conversation table |
| COS.VetHub.Services.SaveClaims | NServiceBus | Downloads Claim and Attachments from VetHub |
| COS.VetHub.Services.ProcessClaims | NServiceBus | Prepares claim object and submits to COS Claim |
| | | Saga |
| COS.Service.Sagas.Claims | NServiceBus | Saga for COS inbound claims workflow into |
| | | Insurance system via Claims API. |
| COS.Service.ValidatePolicy | NServiceBus | Validate Policy number against Insurance records. |
| COS.Service.SubmitClaims | NServiceBus | Submit claim to Insurance system. |
| COS.Service.Sagas.Attachment | NServiceBus | Saga for managing attachments into insurance |
| | | system. |
| COS.Service.ConsolidateClaimAttachments | NServiceBus | Consolidate all attachments into single PDF |
| | | attachment. |
| COS.Service.SubmitClaimAttachment | NServiceBus | Submit claim attachment to insurance system. |

As illustrated in FIG. 1, in this embodiment of this aspect of the disclosure the step of retrieving the claim workflow from the claim workflow database at 17 involves electronically querying the claim workflow database to identify claim workflows eligible for retrieval from said database. In this example the querying step involves periodic polling of the claim workflow database at 17 which on identification of an eligible workflow responds with said workflow. The eligible claim workflow is downloaded from the claim workflow database or associated API 16 for processing at the COS 18 to provide the integrated claim workflow.

Returning to FIG. 2, the processing method of this aspect also comprises the step of receiving supplementary information associated with the animal for which the insurance claim is made. The supplementary information includes but is not limited to claims declarations, medical reports, historical medical records and other documents relevant to the insurance claim for the animal. In this example the supplementary information is received at the API 16 from the VPMS such as 14a. The supplementary information is stored together with the claim workflow in the claim workflow database 17. In this embodiment the step of processing the claim workflow involves consolidating the supplementary information at COS 18 from the claim workflow database into a single data file. The single data file is at COS 18 included in the integrated claim workflow for submission to the insurance provider or UPM 13.

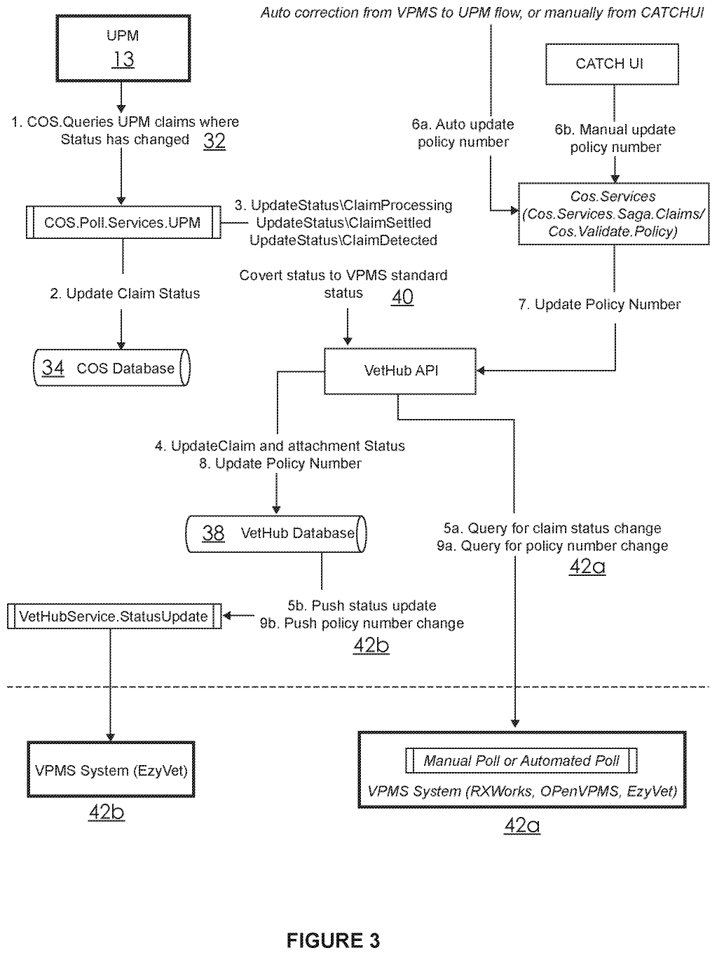

The computer-implemented method of this aspect of processing the insurance claim also comprises the step of validating the policy number from the claim data of the insurance policy under which the insurance claim is made. This is illustrated in the flow diagrams of FIGS. 2 and 3 where at COS 18 the policy number is validated by reconciling it with a corresponding policy number associated with corresponding policy information maintained by the insurance provider or UPM 13. In the event the policy number fails to reconcile with the corresponding policy number, the policy number is either:
1. automatically corrected to the corresponding policy number for return to the relevant VPMS such as 14a via the API 16; or
2. manually updated at COS 18 via insurance staff entering the correct policy number at an insurance user interface (UI) 20 associated with the COS 18.

FIG. 3 illustrates the software platform directed to functionality associated with another aspect of the disclosure in monitoring an insurance claim and in particular the status of the insurance claim. The microservices of this embodiment and of relevance to FIG. 3 are listed below:

| | Type | |
|---|---|---|
| | Windows/ | |
| Service Name | NServiceBus | Description |
| COS.Poll.Services.VetHub | Windows | Poll for conversation which |
| | | are ready to download |
| | | and push them to |
| | | COS.VetHub.Saga.Claims |
| | | queue |
| COS.Poll.Services.UPM | Windows | Periodic poll query to UPM |
| | | insurance system for |
| | | status changes. |

In this embodiment the step of electronically querying the insurance provider 13 in relation to the status of an insurance claim involves periodic polling at 32 of the insurance provider or UPM 13 in relation to the status of the claim. In the event of a change in the status of the insurance claim, the UPM 13 responds to the periodic polling with notification of an updated status to the COS 18.

In this embodiment the method also comprises the step of storing the updated status in an insurance integration database 34 associated with the COS 18. The updated status is converted at 40 from the COS 18 for retrieval and storage in the claim workflow database 38 associated with the API 16 in the compatible data format. In this case the updated status is retrieved by pushing from the insurance integration database or the COS 18 to the claim workflow database or API 16 in the compatible data format.

In this example the step of electronically informing the veterinary practice or VPMS such as 14a of the updated status is effected by prompted delivery of the updated status to the VPMS in the compatible data format. This prompted delivery of the updated status is either i) in response to periodic polling at 42a from the VPMS such as 14a or ii) resulting from periodic pushing of the updated status at 42b to the VPMS such as 14b. The updated status is thus reported to the veterinary practice in substantially real time.

It will be understood that the processing and monitoring methods of these aspects thus enable bi-directional communication of claim data and other information associated with the insurance claim. This bi-directional communication is between the VPMS such as 14a of the veterinary practice and the insurance provider or UPM 13 largely due to:
1. the connected or canonical data model adopted at both the VPMS such as 14a and the workflow database or associated API 16;
2. the integrating nature of the COS 18 in providing a claim workflow format which is compatible with the insurance provider or UPM 13.

As best seen in FIG. 1, it is to be understood that the insurance provider of the disclosure in the context of the preferred embodiment includes the insurance underwriter together with the associated UPM 13, the insurance user interface 20 and insurance staff (not shown) for claims assessment and management. The claim workflow of the disclosure in the context of the preferred embodiment includes API component 16 and the associated claim workflow database 17. The integrated claim workflow of the disclosure in the context of the preferred embodiment includes the COS 18 and the associated insurance integration database.

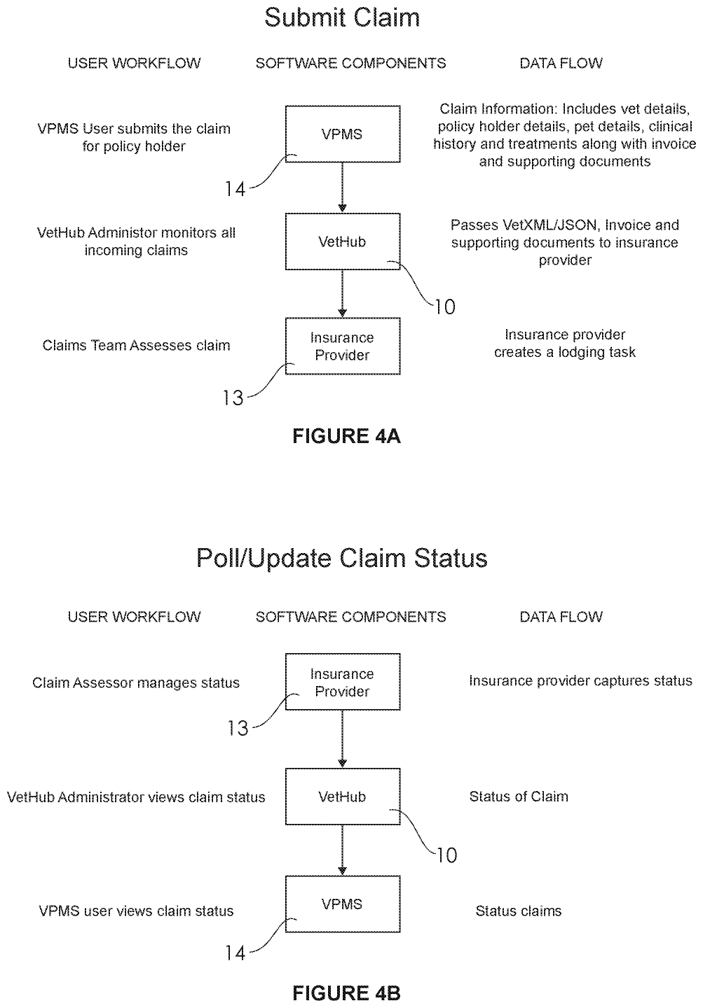

FIGS. 4A and 4B are high level illustrations of the software components relevant to the computer system of further alternative aspects of the disclosure for processing or monitoring an animal insurance claim. In this example and as seen in FIG. 4A, the relevant workflows associated with processing the claim and more particularly submission of the claim are as follows:
1. staff at the veterinary practice 14 submit an insurance claim under an insurance policy for treatment of an animal at the veterinary practice 14;
2. the software platform 10 receives and processes claim data associated with the insurance claim;
3. the insurance provider 13 assesses the insurance claim under the insurance policy for which the treatment of the animal is provided at the veterinary practice 14.

This illustration also details examples of user workflows and data flow in the course of submission and processing of the claim. It will be appreciated that the specific information and data type may vary from the examples listed and still remain within the scope of the disclosure.

FIG. 4B illustrates workflows associated with monitoring the claim and more particularly changes in the status of the insurance claim where:
1. a claims assessor at the insurance provider 13 updates the status of the insurance claim, for example “processing” “failed processing” “settled” or “declined”;
2. the software platform 10 receives notification of the status or change in status of the claim;
3. the veterinary practice or the VPMS 14 is informed of the updated status of the claim.

It will be understood that the methodology adopted by the software platform 10 of the preceding aspects of the disclosure is enabled by the various components of the computer system for processing or monitoring animal insurance claims. These components may be in the form of either software or hardware associated with the software platform 10.

FIG. 1 depicts the specific steps involved in processing or monitoring an insurance claim according to a preferred embodiment of the disclosure. It will be appreciated that the particular order and detail for each of the steps may vary whilst remaining within the broad scope of the disclosure. Following the numbering of the annotated steps in the flow diagram, the method in this embodiment functions as follows:

1a to 1c VPMS calls a vet hub API of the platform to submit the claim in an industry standard canonical model. Vet hub stores the claim, and all attachments in the canonical model format at a claim workflow database.
2. COS polls the vet hub API to query for new claims submitted, and retrieves them to COS from the claim workflow database.
3a. COS validates the policy number of the claim against corresponding UPM data, and automatically corrects an invalid policy number using other fields (name, address, etc).
4. Alternatively, if COS cannot validate the policy number or autocorrect, insurance staff retrieve the claim using an insurance provider UI.
5. Alternatively, if COS cannot validate the policy number or autocorrect, the insurance staff correct the policy number using the UI.
6. COS periodically polls the UPM to see if the claim status has changed, and if so, the updated status is retrieved from the UPM and saved into COS.
7. COS sends the updated status to the vet hub API, which is saved in the canonical model format in the claim workflow database.
8a & 8b VPMS periodically polls the vet hub API querying for claim status changes and/or policy number changes. If changed, it will update the status and communicate this to the veterinary practice or VPMS.
8c. Alternatively, the vet hub API will call VPMS to push claim status changes and/or policy number changes to it. If changed, it will update the status and communicate the updated status to the vet practice or VPMS.

Now that a preferred embodiment of a computer-implemented method of processing or monitoring an insurance claim has been described it will be apparent to those skilled in the art that it has the following advantages:
1. the method and system of the software platform in adopting an industry standard model integrate with the veterinary practice and in particular the VPMS;
2. the method and system are configured for integration with various insurance providers with the insurance integration component of the software platform being tailored for compatibility with the insurance provider or UPM;
3. the method and system significantly reduce the time and effort otherwise required by the policy owner in manually submitting an insurance claim together with supporting documents for reimbursement of benefit amount payable by the insurance provider for the claim.

Those skilled in the art will appreciate that the disclosure as described herein is susceptible to variations and modifications other than those specification described. The workflows, routines or other functionality of the software platform may depart from the preferred embodiment provided it remains broadly within the scope of the broadest aspects of the disclosure. The standard data format of the claim data ingested by the software platform may depart from the canonical model provided the VPMS is compatible with the vet hub API or associated claim workflow database. The retrieval of workflows or other data from either the claim workflow database or the insurance integration database may depart from the poll/respond or push models implemented by the API and COS components of the preferred software platform.

All such variations and modifications are to be considered within the scope of the present disclosure the nature of which is to be determined from the foregoing description.

1. A computer-implemented method of processing an insurance claim, said method comprising the steps of:
receiving claim data associated with an insurance claim for treatment of an animal at a veterinary practice;
processing the claim data to provide a claim workflow derived from said claim data;
storing the claim workflow in a claim workflow database;
retrieving the claim workflow from the claim workflow database;
processing the claim workflow to provide an integrated claim workflow in a format compatible for submission to an insurance provider for assessment of the insurance claim.

2. A computer-implemented method as claimed in claim 1 wherein the step of retrieving the claim workflow from the claim workflow database involves electronically querying the claim workflow database to identify claim workflows eligible for retrieval from the claim workflow database.

3. A computer-implemented method as claimed in claim 2 wherein said step of querying the claim workflow database involves periodic polling of said database which on identification of an eligible claim workflow responds with said workflow.

4. A computer-implemented method as claimed in claim 3 wherein the eligible claim workflow is downloaded from the claim workflow database for processing to provide the integrated claim workflow.

5. A computer-implemented method as claimed in claim 1 also comprising the step of receiving supplementary information associated with the animal for which the insurance claim is made.

6. A computer-implemented method as claimed in claim 5 wherein the supplementary information is stored together with the claim workflow in the claim workflow database.

7. A computer-implemented method as claimed in claim 6 wherein the step of processing the claim workflow involves consolidating the supplementary information from the claim workflow database into a single data file for inclusion in the integrated claim workflow for submission to the insurance provider.

8. A computer-implemented method as claimed in claim 1 also comprising the step of validating a policy number from the claim data of an insurance policy under which the insurance claim is made.

9. A computer-implemented method as claimed in claim 8 wherein the policy number is validated by reconciling it with a corresponding policy number associated with corresponding policy information maintained by the insurance provider.

10. A computer-implemented method as claimed in claim 9 where, in the event the policy number fails to reconcile with the corresponding policy number, the policy number is automatically corrected to the corresponding policy number.

11. A computer-implemented method as claimed in claim 1 wherein the claim data is received from the veterinary practice having been converted into a compatible data format by application of a canonical data model at the veterinary practice.

12. A computer system for processing an animal insurance claim, said system comprising:
a processor;
a memory device which stores a plurality of instructions which when executed by the processor cause the processor to:
receive claim data associated with an insurance claim for treatment of an animal at a veterinary practice;
process the claim data to provide a claim data workflow derived from said claim data;
store the claim workflow in a claim workflow database;
retrieve the claim workflow from the claim workflow database;
process the claim workflow to provide an integrated claim workflow in a format compatible for submission to an insurance provider for assessment of the insurance claim.

13. A computer-implemented method of monitoring an insurance claim, said method comprising the steps of:
electronically querying an insurance provider in relation to a status of an insurance claim for treatment of an animal at a veterinary practice;
in the event of a change in the status of the insurance claim, retrieving an updated status from the insurance provider;
converting the updated status to a compatible data format capable of being read by the veterinary practice;
storing the updated status in the compatible data format in a claim workflow database;
electronically communicating the updated status from the claim workflow database to the veterinary practice in the compatible data format.

14. A computer-implemented method as claimed in claim 13 also comprising the step of storing the updated status in an insurance integration database for conversion to the compatible data format.

15. A computer-implemented method as claimed in claim 14 also comprising the step of retrieving the updated status in the compatible data format for storage in the claim workflow database.

16. A computer-implemented method as claimed in claim 15 wherein said retrieval of the updated status involves pushing the updated status from the insurance integration database to the claim workflow database in the compatible data format.

17. A computer-implemented method as claimed in claim 13 wherein the step of electronically informing the veterinary practice of the updated status in the compatible data format is effected by prompted delivery of the updated status in response to periodic polling from the veterinary practice.

18. A computer-implemented method as claimed in claim 13 wherein the updated status in the compatible data format is communicated to the veterinary practice by calling the veterinary practice for pushing of the updated claim status to said practice.

19. A computer-implemented method as claimed in claim 13 wherein the step of electronically querying the insurance provider involves periodically polling the insurance provider in relation to the status of the insurance claim.

20. A computer-implemented method as claimed in claim 19 where, in the event of a change in the status, the step of retrieving the updated status involves the insurance provider responding to the periodic polling with the updated status.
